(19) United States
(12) Patent Application Publication
(10) Pub. No.: US 2016/0035475 A1
(43) Pub. Date: Feb. 4, 2016

(54) REACTOR

(71) Applicant: Tamura Corporation, Tokyo (JP)

(72) Inventors: Kensuke Maeno, Saitama (JP); Toshikazu Ninomiya, Saitama (JP); Masashi Yamada, Saitama (JP)

(21) Appl. No.: 14/814,250

(22) Filed: Jul. 30, 2015

(30) Foreign Application Priority Data
Jul. 31, 2014 (JP) 2014-157121

(51) Int. Cl. H01F 27/26; H01F 27/32; H01F 27/255; H01F 27/28

(52) U.S. Cl. CPC H01F 27/263; H01F 27/2823; H01F 27/325; H01F 27/255

(57) ABSTRACT

A reactor 10 includes a core, a coil 11 and a bobbin 14. The core includes a plurality of core pieces 12, 13A, 13B that are joined one another. The coil is wound around at least a part of the core. The bobbin is dividable and provided between the core and the coil. A dividing surface 50 of the bobbin is displaced from a position of a joining surface of the core pieces with the bobbin that is provided between the core and the coil.

### CROSS-REFERENCE TO RELATED APPLICATION

This application is based upon and claims the benefit of priority from Japanese Patent Application NO. 2014-157121, filed on Jul. 31, 2014; the entire contents of which are incorporated herein by reference.

### FIELD OF THE INVENTION

The present invention relates to a reactor that has enhanced joining force between core pieces.

### BACKGROUND

In order to suppress an inductance reduction, conventionally, in-vehicle reactors are known which have a magnetic gap with a predetermined width between plural core pieces. According to this type of reactors, a ceramic spacer, etc., is placed in the gap between core pieces, and the core piece and the adjoining spacer are bonded together by an adhesive, thereby obtaining an integrated core.

As an integrated core made by gathering plural core pieces, annular cores are known. According to annular cores, U-shaped cores are disposed at both ends so as to face with each other, and I-shaped cores are disposed between those U-shaped cores. Hence, a substantially annular closed magnetic path with the I-shaped cores and the U-shaped cores being as the magnetic path is formed. Coils are wound around such a core, and thus a reactor is formed. In addition, a resin-made bobbin for the insulation between the core and the coils is provided between the core and the coils. The bobbin formed by resin molding covers the cores, and the core covered around by the resin is called a mold core.

As for materials applied to the cores, a laminated steel sheet that includes plural magnetic steel sheets has been applied, but in view of the magnetic saturation and the costs, recently, powder magnetic cores are becoming popular. Powder magnetic cores have minute gaps between magnetic powders. Hence, magnetic saturation is not prone to occur, and an air gap to be inserted between the cores can be downsized. Therefore, according to reactors that include a powder magnetic core, leakage fluxes can be reduced, and the whole reactor can be downsized (see JP 2008-078219 A and JP 2013-197567 A).

When the plural core pieces are combined to form an integrated core, an adhesive is applied to the joining surface of the core pieces.

### SUMMARY

The present invention has been proposed to provide a reactor which has enhanced joining force between a core piece and a bobbin to improve joining force between the core pieces by applying an adhesive so as to overflow from the joining surface of the core pieces, and which can surely suppress a misalignment of the core pieces relative to each other and a detachment of the bonded core pieces.

In order to accomplish the above objective, the present invention is directed to a reactor that comprises a core including plural core pieces joined one another, a coil wound around the core, and a bobbin provided between the core and the coil. The present invention has following features.

(1) The bobbin is dividable, and with the bobbin being provided between the core and the coil, the dividing surface of the bobbin is displaced from a joining surface of the core pieces.

(2) An adhesive may be applied to the joining surface of the core pieces so as to overflow from the joining surface and stick to an internal wall surface of the bobbin.

(3) The core piece of the core around which the coil is wound may be an I-shaped core, and the dividing surface of the bobbin may be disposed near the center of the I-shaped core in such a way that the divided bobbin members cover the I-shaped core evenly.

(4) The bobbin may be formed with an opening through which the adhesive overflows to the exterior of the bobbin from bobbin-internal-wall-surface side.

(5) The position of the opening may overlap the joining surface of the core pieces or may be located near the joining surface.

(6) The opening may be located near the center of the core piece in the width direction.

(7) The opening may be formed along the joining surface of the core pieces.

(8) The core may include a yoke portion and right and left leg portions, a resin member may be molded on the yoke portion, the bobbin integrally formed with the resin member may be provided at the right and left leg portions, and the yoke portion may be integrally formed with a positioning portion that guides a drawn wire from the coil.

(9) At least one of the divided bobbin member may include a cylindrical portion that supports the core piece.

(10) The core may be an annular core that includes U-shaped cores disposed at both ends so as to face with each other, and I-shaped cores held and disposed between the U-shaped cores. The bobbin may be dividable in an orthogonal direction to the axial direction of the annular core.

(11) The core piece may be a powder magnetic core.

According to the reactor of the present invention, the position of the dividing surface of the bobbin and the joining surface of the core pieces are displaced from each other. Hence, even if the joined core pieces are detached, the core pieces can be surely held in the bobbin.

In addition, by applying an adhesive so as to overflow from the joining surface of the core pieces, the bonding force between the core piece and the bobbin can be enhanced. Accordingly, the joining force between the core pieces can be enhanced, and the misalignment of the joined core pieces and the detachment thereof can be prevented. In addition, the core pieces can be surely held in the bobbin.

### BRIEF DESCRIPTION OF THE DRAWINGS

FIG. 1 is an exploded perspective view according to a first embodiment with coils being eliminated;

FIG. 2 is a perspective view according to the first embodiment;

FIG. 3 is an exploded perspective view according to the first embodiment with a bobbin being detached;

FIG. 4 is a perspective view of the bobbin of the first embodiment;

FIG. 5 is a plan view of the bobbin of the first embodiment;

FIG. 6 is a perspective view of a first bobbin member of the first embodiment;

FIG. 7 is a plan view of the first bobbin member and a core according to the first embodiment;

FIG. 8 is a perspective view of a second bobbin member of the first embodiment;

FIG. 9 is a plan view of the second bobbin member and the core according to the first embodiment;

FIG. 10 is a plan view of a fitting condition of the core and gap spacers in the first bobbin member of the first embodiment;

FIG. 11 is a plan view of a major portion of the first embodiment; and

FIG. 12 is an exploded perspective view of a second embodiment with coils being eliminated.

### DETAILED DESCRIPTION OF THE EMBODIMENTS

### First Embodiment

(Structure)

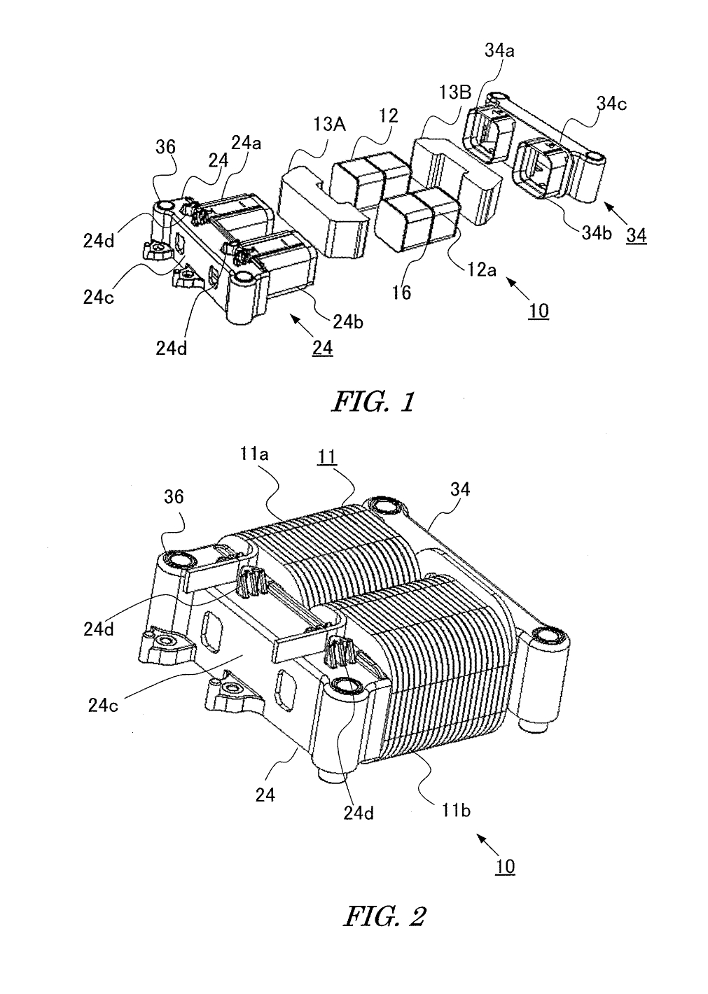

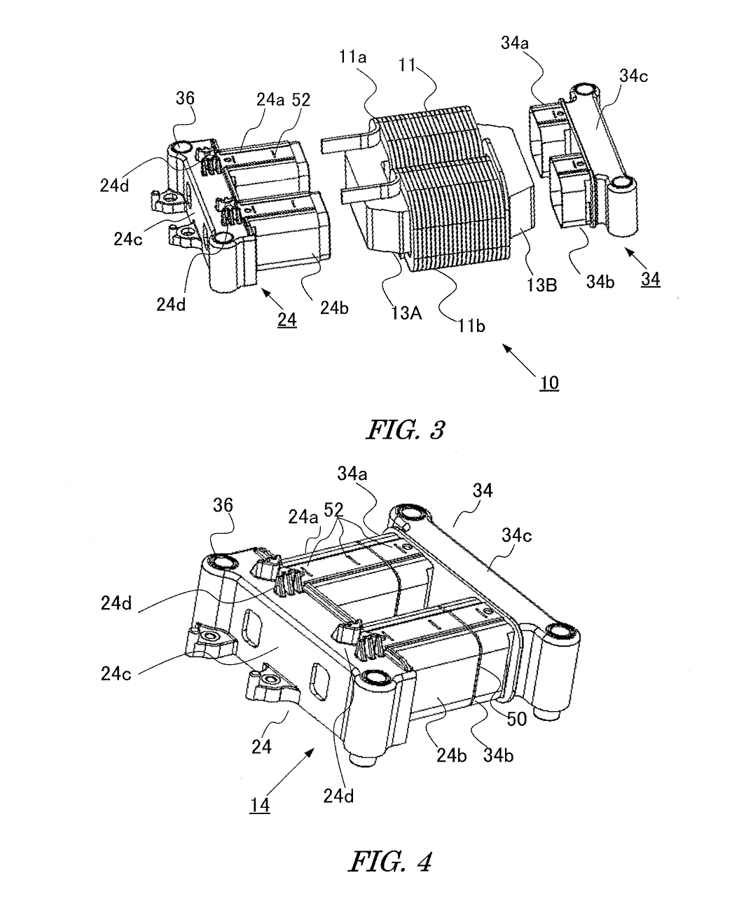

A detailed explanation will be given below of a first embodiment of the present invention with reference to FIGS. 1 to 12. First, with reference to FIGS. 1 to 3, an outline of the structure of a reactor 10 according to the first embodiment will be explained. FIG. 1 is an exploded perspective view according to the first embodiment with coils being eliminated. FIG. 2 is a perspective view according to the first embodiment. FIG. 3 is an exploded perspective view according to the first embodiment with a bobbin being detached. The reactor 10 illustrated in those figures is a large-capacity reactor applied to, for example, a drive system for hybrid vehicles or electric vehicles.

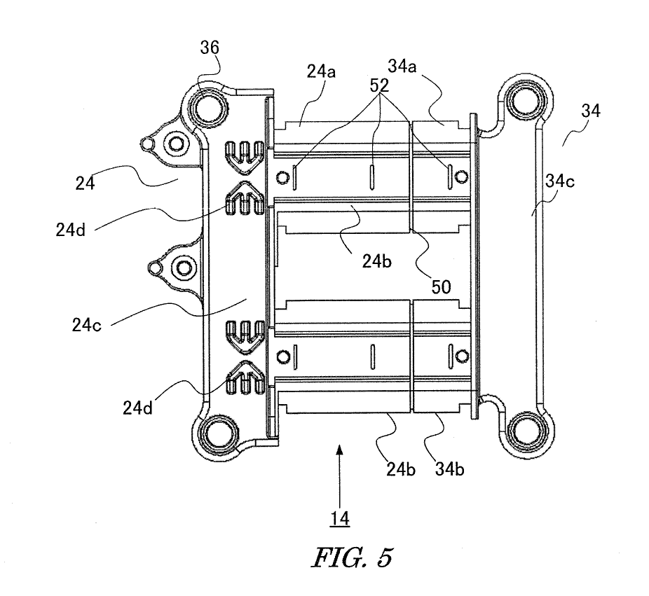

As illustrated in FIG. 1, the reactor 10 includes two I-shaped cores 12, two U-shaped cores 13A, 13B (those I-shaped cores 12 and U-shaped cores 13A, 13B are sometimes simply referred to as cores 12 and cores 13A, 13B), plural gap spacers 16, and a first bobbin member 24 and a second bobbin member 34 that can be divided into the respective two members. In addition, as illustrated in FIG. 2, coils 11 are wound around the integrated bobbin members 24, 34. The bobbin members 24, 34 integrated with each other will be referred to as a bobbin 14 (see FIGS. 4 and 5 to be explained later). FIG. 3 illustrates a condition in which the bobbin 14 is detached from the coils 11 and the cores 12, 13A, and 13B, and illustrates a positional relationship among the coils 11 and the cores 12, 13A, and 13B. Collars 36 through which a fastener like a screw completely passes are integrally formed at the four corners of the bobbin 14.

(Coils)

As illustrated in FIGS. 2 and 3, the reactor 10 has the pair of coils 11 that are heat generation sources disposed side by side in parallel with each other. The coils 11 include respective linear coil members 11a, 11b with the same structure and disposed in parallel with each other. Respective one ends of the coil members are coupled with each other as a coupling line. Hence, a coupling coil is formed. Example schemes of coupling the coupling coil are welding or soldering of the right and left linear coil members 11a, 11b, and cold welding. In addition, drawn wires are provided at the respective other ends of the coils 11.

The linear coil members 11a, 11b are each, for example, an edgewise coil including a rectangular wire bent at a right angle at four locations per a turn and turned in a substantially square shape. Various conductors are applicable to the wiring of the coil 11, and for example, such a wire may be turned in a substantially circular shape or a substantially elliptic shape. The hollows of the linear coil members 11a, 11b are each formed in a substantially rectangular shape with rounded four corners which appears when cut in an orthogonal direction to the turning direction.

(Core)

As illustrated in FIG. 1, the reactor 10 includes the I-shaped cores 12 and U-shaped cores 13A, 13B. The sheet or tabular gap spacers 16 are held between the pieces of I-shaped core 12, and between the I-shaped cores 12 and the U-shaped cores 13A, 13B. The cores 12, 13A, and 13B are joined with the gap spacers 16.

Since the pieces of I-shaped core 12, and the I-shaped cores 12 and the U-shaped cores 13A, 13B are joined one another via the gap spacers 16, the joining surfaces of the cores 12, 13A, and 13B indicate the joining surface between the I-shaped core 12 and the gap spacer 16, and also the joining surfaces between the U-shaped cores 13A, 13B and the gap spacer 16. That is, the positions of the joining surfaces of the core 12, 13A, and 13B are substantially consistent with the positions of the gap spacers 16.

The I-shaped cores 12 are disposed at the respective hollows of the linear coil members 11a, 11b, and are disposed in parallel with each other. In addition, the U-shaped cores 13A, 13B are disposed in such a way that respective pairs of leg portions face with each other, and the I-shaped core 12 is joined between the leg portions of the respective U-shaped cores at one side. Hence, a substantially annular closed magnetic path is formed which has the I-shaped cores 12 and the U-shaped cores 13A, 13B as the magnetic path.

The annular core is formed by those I-shaped cores 12, U-shaped cores 13A, 13B, and the gap spacers 16. The coils 11 are wound around the annular core, and the whole I-shaped cores 12 and the leg portions of the U-shaped cores 13A, 13B are disposed in the hollows of the linear coil members 11a, 11b. The yoke portions of the U-shaped cores 13A, 13B are located outside the hollows of the linear coil members 11a, 11b (see FIG. 3).

The I-shaped cores 12 and the U-shaped cores 13A, 13B may be a powder magnetic core, may be formed of a laminated steel sheet that includes plural magnetic steels, or may be a ferrite core or an amorphous core. When, for example, the I-shaped cores 12 and the U-shaped cores 13A, 13B are each a powder magnetic core, those cores can be formed by pressing magnetic powders. Example magnetic powders applicable are an appropriate combination of metal powders, such as pure iron, a silicon-iron alloy, and an aluminum-silicon-iron alloy, and by adjusting those materials and gap dimensions, a reactor that has various reactor characteristics can be obtained.

The I-shaped core 12 may be formed in a substantially columnar shape, and the shape and the dimension, etc., can be changed as needed. In addition, the I-shaped core 12 has an external pressed surface which is formed in a rectangular shape with chamfered portions 12a (see FIG. 1) located at four corners.

The chamfered portions 12a of the I-shaped core 12 are cut across the width direction (lengthwise direction of the annular core) of the I-shaped core 12 at the same angle and in parallel with each other on each diagonal line. At this time, the shapes of inner circumferences of leg portions 24a, 24b of the first bobbin member 24 and those of the second bobbin member 34 may be made similar to the cross-sectional shape of the I-shape core 12 so that designing which can reduce the clearance and which can increase the cross-sectional area of the I-shaped core 12 is possible.

(Gap Spacers)

The gap spacer 16 is a tabular member formed of a non-magnetic material, such as various ceramics like alumina, and a resin. All gap spacers 16 are disposed in the hollows of the linear coil members 11a, 11b. In this case, the spacers to form a gap are held between the opposing surfaces of the pieces of I-shaped core 12 and between the opposing surfaces of the I-shaped core 12 and those of the U-shaped cores 13A, 13B, but the spacer may be eliminated. For example, an adhesive may be applied instead of the spacer.

(Bobbin)

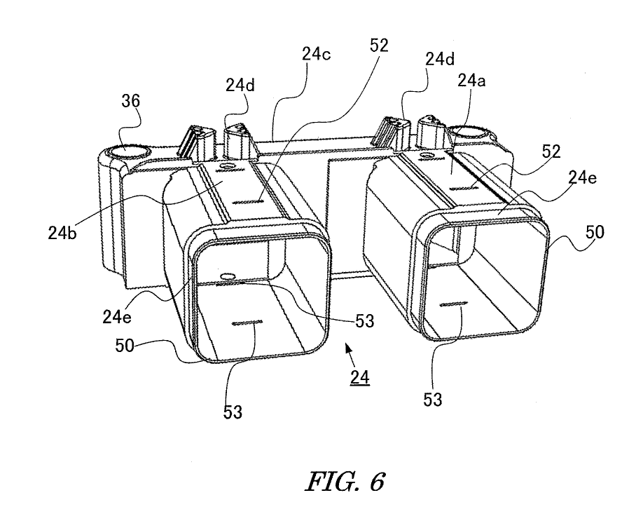

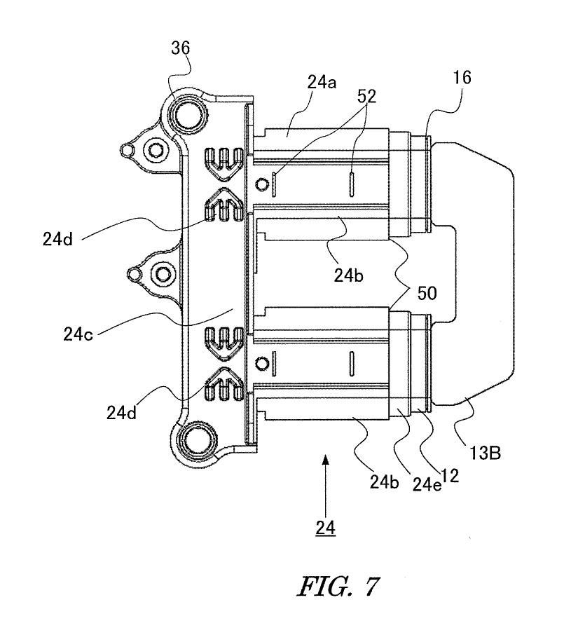

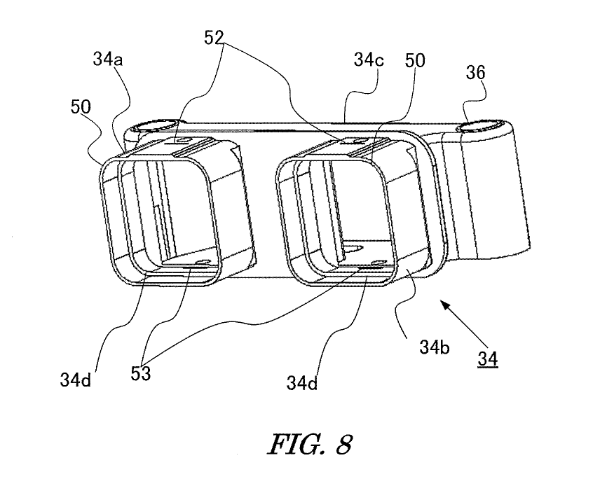

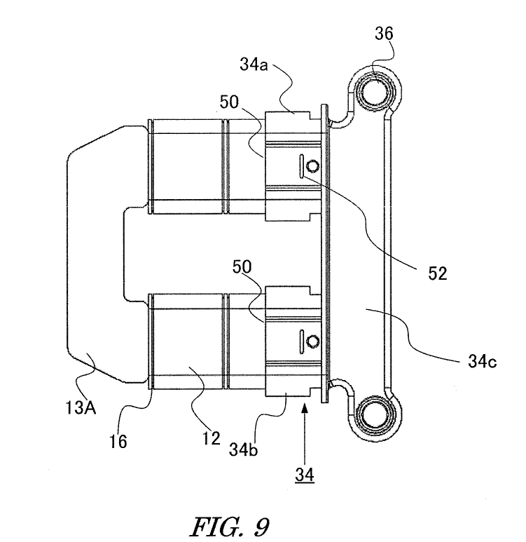

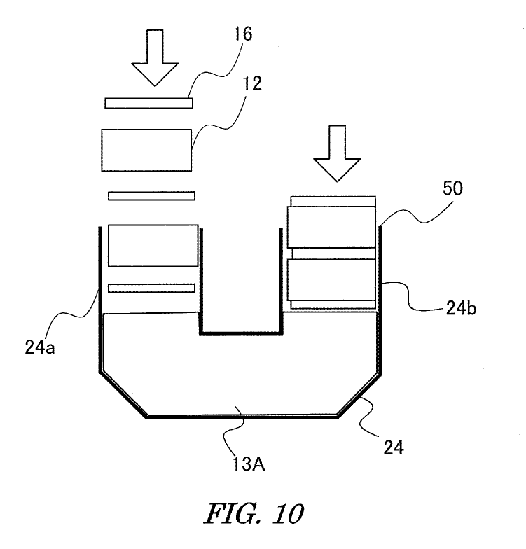

An explanation will be given of the bobbin 14 with reference to FIGS. 4 to 10. As explained above, the reference numeral 14 in FIGS. 4 and 5 indicates the bobbin with the bobbin members 24 and 34 integrated with each other. FIGS. 4 and 5 are a perspective view and a plan view of the whole bobbin, and FIG. 6 is a perspective view of the first bobbin member. FIG. 7 is a plan view of the first bobbin and the U-shaped core, and FIG. 8 is a perspective view of the second bobbin member. FIG. 9 is a plan view of the I-shaped core and the U-shaped core, and FIG. 10 is a plan view illustrating a fitting work of the cores and the gap spacers to the first bobbin member.

The bobbin 14 is a resin mold component, and insulates the coils 11 from the cores 12, 13A, and 13B. Example materials of the bobbin 14 applicable are an unsaturated-polyester-based resin, an urethane resin, an epoxy resin, a BMC (Bulk Molding Compound), PPS (Polyphenylene-Sulfide), and PBT (Poly-Butylene-Terephthalate).

As illustrated in FIGS. 4 and 5, the bobbin 14 can be divided into two members in the direction (the horizontal direction in FIG. 1) orthogonal to the axial direction of the annular core that includes the cores 12, 13A, and 13B. The bobbin 14 includes the first bobbin member 24 and the second bobbin member 34. The bobbin 14 with the assembled two bobbin members 24 and 34 retains thereinside the whole annular core that includes the I-shaped cores 12, the U-shaped cores 13A, 13B, and, the gap spacers 16.

The dividable direction of the bobbin 14 is a horizontal direction along the lengthwise direction of the annular core. The divided first and second bobbin members 24 and 34 have the respective U-shaped cores 13A, 13B buried in the respective bobbin members, and are integrated with the respective U-shaped cores 13A, 13B. FIGS. 4 and 5 illustrate a condition in which the first and second bobbin members 24 and 34 are assembled and become the single bobbin 14.

With the bobbin 14 being provided between the cores 12, 13A, 13B and the coils 11, dividing surfaces of the bobbin 14 and the joining surfaces of the cores 12, 13A, 13B are displaced from one another. That is, the joining surfaces of the first and second bobbin members 24, 34 which are the dividing surfaces 50 of the bobbin 14, and, the positions of the gap spacers 16 which are joining surfaces of the pieces of the I-shaped core 12 are disposed so as not to overlap one another. This is a feature of this embodiment.

An explanation will be given of the first bobbin member 24 between the two members that form the bobbin 14. As illustrated in FIGS. 4 to 7, the first bobbin member 24 includes the right and left leg portions 24a, 24b, and a yoke portion 24c that couples those leg portions. The U-shaped core 24 or 34 is embedded in the yoke portion 24C. The right and left leg portions 24a, 24b of the first bobbin member 24 are each formed in a cylindrical shape so as to retain thereinside the I-shaped core 12.

In order to clearly distinguish which U-shaped core 13A or 13B is embedded in either bobbin member, the U-shaped core embedded in the first bobbin member 24 as illustrated in FIGS. 9 and 10 is defined as the U-shaped core 13A. In addition, the U-shaped core embedded in the second bobbin member 34 in FIG. 7 is defined as the U-shaped core 13B.

As illustrated in FIG. 10, two pieces of the I-shaped core 12 with the gap spacer 16 therebetween are fitted in each leg portion 24a, 24b of the first bobbin member 24. The pieces of I-shaped core 12 and the gap spacers 16 are alternately fitted in each leg portion 24a, 24b of the first bobbin member 24.

However, the joining portions between the I-shaped cores 12 and the U-shaped core 13B (at the second-bobbin-34 side) are disposed outside the leading ends of the leg portions 24a, 24b. Hence, as illustrated in FIG. 7 with the second bobbin member 34 being eliminated from the whole bobbin 14, the U-shaped core 13B embedded in the second bobbin member 34, and a part of the I-shaped core 12 joined with such a core are exposed from the first bobbin member 24.

Two sets of positioning portions 24d are provided on the yoke portion 24c of the first bobbin 24 so as to protrude upwardly. As illustrated in FIG. 2, the positioning portions 24d are formed so as to have arrow leading ends facing with each other, and the drawn wire is held between those arrow leading ends. The drawn wire in this condition is welded to a bus bar.

In addition, flange portions 24e are formed at the leading ends of the leg portions 24a, 24b of the first bobbin member 24, and are located inwardly relative to the respective outer circumferences of the leg portions 24a, 24b (see FIGS. 6 and 7). The flange portions 24e are disposed so as to enter respective leg portions 34a, 34b of the second bobbin member 34.

The inner circumferences of the leg portions 24a, 24b of the first bobbin member 24 are formed in a similar shape to that of the inner circumference of the I-shaped core 12 but are slightly larger. A gap between those inner circumferences is, for example, substantially 0.3 mm. In addition, the surfaces of the end portions of the U-shaped core 13A embedded in the yoke portion 24c of the first bobbin member 24 and the surfaces of the respective I-shaped cores 12 are disposed so as to have the respective gap spacers 16 therebetween.

Next, an explanation will be given of the second bobbin member 34. As illustrated in FIGS. 8 and 9, the second bobbin member 34 includes the left and right leg portions 34a, 34b, and a yoke portion 34c that couples those leg portions. Like the first bobbin member 24, the U-shaped core 13B is embedded in the yoke portion 34c. In addition, openings of the respective leading ends of the leg portions 34a, 34b have the substantially same sizes as those of the leg portions 24a, 24b of the first bobbin member 24.

However, the leg portions 34a, 34b of the second bobbin member 34 have the shorter lengths than those of the leg portions 24a, 24b of the first bobbin member 24. Hence, when the second bobbin member 34 and the first bobbin member 24 are assembled and integrated together, the leg portions 34a, 34b cover only a part of the I-shaped cores 12 joined with the U-shaped core 13B at the second-bobbin-member-34 side (see FIG. 9).

The flange portions 24e of the first bobbin member 24 enter the leg portions 34a, 34b of the second bobbin member 34, respectively. In this case, the leg portions 34a, 34b are formed with steps 34d (see FIG. 8), respectively, so as to abut the leading ends of the flange portions 24e. When the flange portion 24e of the first bobbin member 24 and the steps 34 of the second bobbin member 34 abut with each other, the two bobbin members 24, 34 are positioned, and thus both members are assembled and integrated together.

Hence, the leading ends of the leg portions 24a, 24b and the leading ends of the leg portions 34a, 34b serve as the dividing surfaces 50 of the bobbin 14. The position of the dividing surface 50, i.e., the position of the joining surface between the first and second bobbin members 24, 34 is displaced from the position of the gap spacer 16 which is the joining surface between the U-shaped core 13B at the second-bobbin-member-34 side and the I-shaped core 12 (illustrated in FIG. 10 at the leg-portion-24b side of the first bobbin member 24).

That is, as illustrated in FIG. 7, when the first bobbin member 24 is viewed from the upper space, the end surface of the first bobbin member 24 is located at the left side, while the gap spacer 16 is located at the right side. In other words, the dividing surface 50 of the bobbin 14 (the joining surface of the first and second bobbin members 24, 34) is located closer to the yoke portion 24c of the first bobbin member 24 than the joining surface between the U-shaped core 13B and the I-shaped core 12.

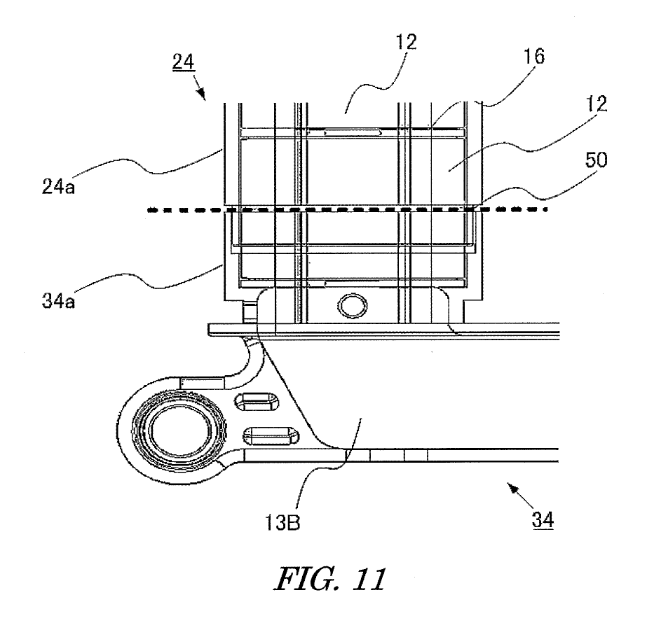

This indicates that the I-shaped core 12 is located below the dividing surface 50, but no gap spacer 16 equivalent to the joining surface between the cores 12, 13B is located below the dividing surface 50 (see FIGS. 9 and 11). As explained above, as a feature of this embodiment, the dividing surfaces 50 of the bobbin 14 are all displaced from the joining surfaces of the cores 12, 13A, and 13B. In addition, the dividing surfaces 50 of the bobbin 14 are disposed near the centers of the respective I-shaped cores 12 in such a way that the divided two bobbin members 24, 34 evenly cover the respective I-shaped cores 12.

The reactor 10 employing the above structure may be provided with a cooling structure. For example, the reactor 10 may be placed in a casing that is provided with cooling plates. In addition, the reactor 10 may be disposed at a location within a flow channel of a cooling medium, or the cooling medium may be poured on the reactor 10. An example suitable cooling medium is an insulation oil.

(Action and Effect)

According to the first embodiment, the core that includes the plural cores 12, 13A, and 13B joined together is provided, the coils 11 are wound around those cores 12, 13A, and 13B, and the bobbin 14 is provided between the cores 12, 13A, 13B and the coils 11, thereby forming the reactor 10. This reactor 10 has the following action and effect.

(1) When the plural core pieces are combined to form an integrated core, an adhesive is applied to the joining surface of the core pieces. However, external vibrations are applied to the reactor, so that the reactor itself vibrates. Hence, the bonding force between the core pieces may decrease, causing a misalignment of the core pieces relative to each other, and a detachment of the bonded core pieces. According to conventional technologies, with the bobbin members 24, 34 being provided between the cores 12, 13A, 13B and the coils 11, the positions of the dividing surfaces 50 of the bobbin 14 and the joining surfaces between the I-shaped cores 12 and the U-shaped core 13B are aligned. Hence, if the I-shaped cores 12 and the U-shaped core 13B are detached from each other, and the bobbin members 24, 34 are misaligned from the originally intended positions, although the amount of misalignment is little, the U-shaped core 13B and the gap spacers 16 may be misaligned relative to the leg portions 34a of the bobbin member 34. In contrast, according to this embodiment, with the bobbin 14 being provided between the cores 12, 13A, 13B and the coils 11, the positions of the dividing surfaces 50 of the bobbin 14 are displaced from the joining surfaces of the cores 12, 13A, 13B, and both are not aligned one another. Therefore, even if the I-shaped cores 12 and the U-shaped core 13B are detached from each other, the U-shaped core 13B and the gap spacer 16 may be surely held inside the bobbin members 24, 34.

In addition, the bobbin members 24, 34 can be divided near the centers of the respective I-shaped cores 12. Hence, the leg portions 24a, 24b of the first bobbin member 24 and the leg portions 34a, 34b of the second bobbin member 34 cover the I-shaped cores 12 with an even balance. Therefore, the misalignment of the annular core relative to the bobbin 14 can be further effectively suppressed.

(2) According to this embodiment, since the positions of the dividing surfaces 50 of the bobbin 14 are displaced from the joining surfaces of the cores 12, 13A, and 13B, as illustrated in FIG. 7, the joining portions between the I-shaped cores 12 and the U-shaped core 13B protrude from the leading ends of the respective leg portions 24a, 24b of the first bobbin member 24. That is, when the I-shaped cores 12 to be joined with the U-shaped core 13B at the second-bobbin-member-34 side are fitted in the first bobbin member 24, the I-shaped cores 12 partially exposed from the leg portions 24a, 24b of the first bobbin member 24. Hence, a fitting work of the I-shaped cores 12 can be performed with such exposed portions being held. Accordingly, the easiness of the work when the I-shaped cores 12 are fitted in the bobbin 14 can be improved.

(3) Cylindrical portions that support the respective I-shaped cores 12 are provided at the first bobbin member 24. That is, according to this embodiment, the right and left leg portions 24a, 24b of the first bobbin member 24 serve as such cylindrical portions which retain thereinside and hold the I-shaped cores 12, respectively. Accordingly, the leg portions 24a, 24b serve as guides that support the respective I-shaped cores 12 from the bottom side.

Hence, when the I-shaped cores 12 are fitted in such guides, the assembling of the I-shaped cores 12 can be facilitated. Consequently, the easiness of the assembling work of the I-shaped cores 12 can be improved, and the costs for this work can be reduced. This is advantageous in view of economic efficiency. In addition, the cores 12, 13A, 13B and the gap spacers 16 can be highly precisely positioned, and thus the reactor 10 can accomplish the performance as originally designed.

(4) Powder magnetic cores have lower Young's modulus than that of a laminated steel sheet, and thus vibrations are prone to increase due to an adverse effect of electromagnetic attractive force. In addition, powder magnetic cores have a lower mechanical strength than that of cores formed of a laminated steel sheet. Therefore, enhancement of bonding force between core pieces has been an urgent necessity for powder magnetic cores. In this embodiment, the cores 12, 13A, and 13B are each a powder magnetic core, but by applying this embodiment to the cores 12, 13A and 13B which are relatively weak to vibration, the misalignment and detachment of the joined cores 12, 13A, and 13B can be surely prevented. Hence, although the cores 12, 13A, and 13B are each a powder magnetic core, the adverse effect of vibration can be reduced, thereby improving the joining force.

(5) In this embodiment, the core pieces inserted in the bobbin members 24, 34 are only the U-shaped cores 13A, 13B, respectively, and the number of cores to be set within a molding die is small. Therefore, the core piece within the molding die can be easily and precisely positioned.

(6) The I-shaped cores 12 and the gap spacers 16 are attached to the first bobbin member 24 only, and an attaching work of the I-shaped cores 12 and the gap spacers 16 to the second bobbin member 34 is unnecessary. Hence, the attaching work can be completed at one time, reducing the costs for this work.

(7) By the two sets of positioning portions 24d provided on the yoke portion 24c of the first bobbin member 24, the drawn wires of the coils 11 can be easily positioned. When the coils 11 are attached to the first bobbin member 24, assembling is performed with the leg portions 24a, 24b standing upright. In this case, since the positioning portions 24d are provided, the attaching direction of the coil 11 is not mistaken, making the easiness of the assembling work excellent.

### Second Embodiment

(Structure)

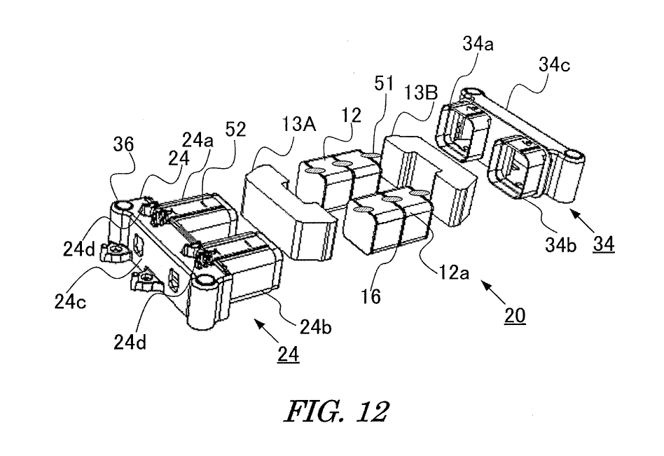

A second embodiment will be explained in detail with reference to FIG. 12. In the second embodiment, since the basic structure is the same as that of the first embodiment, the explanation will be given with reference to also FIGS. 2 to 11. The same element as that of the first embodiment will be denoted by the same reference numeral, and the duplicated explanation will be omitted.

A feature of the second embodiment is that an adhesive 51 is applied to the joining surfaces of the cores 12, 13A, and 13B so as to overflow from the joining surfaces and stick to the internal wall surface of the bobbin 14. In addition, as a feature of the second embodiment, openings 52, 53 are formed in the bobbin 14.

(Cores)

A reactor 20 of the second embodiment includes, like the first embodiment, the I-shaped cores 12 and the U-shaped cores 13A, 13B. The pieces of the I-shaped core 12 and the I-shaped cores 12 and the U-shaped cores 13A, 13B are joined via the gap spacers 16, but the adhesive 51 is applied to such joining surfaces.

As explained above, the joining surfaces of the cores 12, 13A, and 13B are joining surfaces between the I-shaped core 12 and the gap spacers 16 and joining surfaces between the U-shaped cores 13A, 13B and the gap spacers 16 as explained above. Hence, the adhesive 51 overflowing from the joining surfaces of the cores 12, 13A, and 13B overflows from the joining surfaces between the I-shaped core 12 and the gap spacers 16, and the joining surfaces between the U-shaped cores 13A, 13B and the gap spacers 16. Such an adhesive 51 spreads so as to cover the outer circumference of the gap spacer 16. In FIG. 12, in order to facilitate understanding for the arrangement of the gap spacers 16, the adhesive 51 is illustrated only on the upper face of the I-shaped core 12.

According to the second embodiment, also, the positions of the dividing surfaces 50 of the bobbin 14 are displaced from the joining surfaces of the cores 12, 13A, and 13B. In addition, as explained above, the gap between the leg portions 24a, 24b of the first bobbin member 24 and the respective I-shaped cores 12 is merely 0.3 mm or so. Hence, the adhesive 51 overflowing from the joining surfaces of the cores 12, 13A, and 13B surely sticks to the internal wall surface of the bobbin 14 located above those cores.

As already explained above, since the whole annular core that includes the I-shaped cores 12 and the U-shaped cores 13A, 13B are retained in the bobbin 14, the adhesive 51 overflowing from the joining surfaces of the cores 12, 13A, and 13B further overflows from the openings 52, 53 to the exterior, and this adhesive 51 sticks to the coils 11.

(Adhesive)

The adhesive 51 applied to join the cores 12, 13A, and 13B one another may be, in addition to an epoxy-based adhesive or a silicon-based adhesive, a thermosetting type or a moisture curing type, and the type of such an adhesive can be selected freely. In addition, an adhesive to which a specific function is added, such as insulation properties or anti-vibration properties, can be also selectable as needed.

(Openings)

The openings 52 are provided at three locations in the bobbin 14 as viewed from the upper space and are aligned on the substantially straight line (see FIGS. 3 to 9). Openings 53 (see FIGS. 6 and 8) corresponding to the respective openings 52 are provided in the bottom face of the bobbin 14. The six openings 52, 53 in total are opened along the respective joining surfaces of the cores 12, 13A, and 13B, and the adhesive 51 overflows from those openings to the exterior from bobbin-internal-wall-surface side. The respective positions of the openings 52, 53 overlap the respective joining surfaces of the cores 12, 13A, and 13B. The respective positions of the openings 52, 53 may be located near the respective joining surfaces of the cores 12, 13A, and 13B.

As illustrated in FIGS. 4 and 5, the three openings 52, 53 arranged side by side are disposed at respective locations corresponding to the respective gap spacers 16. All openings 52, 53 are disposed near the center in the width direction of the I-shaped core 12.

In addition, the openings 52, 53 are each a slit hole. In the openings 52, 53, the lengthwise direction of the slit hole is in parallel with the corresponding joining surface of the cores 12, 13A, and 13B, i.e., extends so as to be orthogonal to the lengthwise direction of the first bobbin member 24.

(Action and Effect)

The action and effect of the second embodiment employing the above structure are as follows.

(1) The adhesive 51 is applied to the joining surfaces of the cores 12, 13A, and 13B so as to overflow from such joining surfaces and stick to the internal wall surface of the bobbin 14. Hence, the adhesive 51 is cured with the internal wall surface of the bobbin 14, and thus the joining force between the bobbin 14 and the cores 12, 13A, and 13B increases. Accordingly, the pieces of the I-shaped core 12, and, the I-shaped cores 12 and the U-shaped cores 13A, 13B are bonded to the bobbin 14 through the upper faces and the bottom faces running in the horizontal direction in addition to the joining surfaces running in the vertical direction.

Hence, the joining force between the bobbin 14 and the I-shaped cores 12, and also the U-shaped cores 13A, 13B increases. Consequently, even if an adverse effect of vibration is applied, the misalignment of the cores 12, 13A, and 13B from one another is prevented, and thus detachment of the joined cores 12, 13A, and 13B from one another can be suppressed. Therefore, the cores 12, 13A, and 13B can be surely held in the bobbin 14.

In addition, when the first bobbin member 24 with which the cores 12, 13A have been assembled is assembled and integrated with the second bobbin member 34 with which the U-shaped core 13B has been assembled, the dividing surfaces 50 of the bobbin 14 are exposed to the exterior. According to such a condition of the bobbin members 24, 34 prior to the assembling, the joining surfaces of the cores 12, 13A, and 13B are not exposed to the exterior, and are located inside the bobbin members 24, 34.

Hence, when the I-shaped cores 12 are fitted in the respective leg portions 24a, 34a of the first bobbin member 24 with the gap spacers 16, the overflowing adhesive 51 around the gap spacers 16 that are the joining surfaces of the cores 12, 13A all spreads over the internal wall surfaces of the leg portions 24a, 24b of the first bobbin member 24. Therefore, the I-shaped cores 12 can be surely held in the first bobbin member 24.

In addition, in the second bobbin member 34, the adhesive 51 overflows from the areas between the U-shaped core 13B in the yoke portion 34c and the respective gap spacers 16, and this adhesive 51 also all spreads over the internal wall surfaces of the leg portions 34a, 34b of the second bobbin member 34. Hence, the widespread adhesive 51 can stick to the leg portions 24a, 24b of the first bobbin member 24 and the leg portions 34a, 34b of the second bobbin member 34. This firmly bonds the cores 12 and 13B together.

As explained above, according to this embodiment, in the structure in which the bobbin 14 is divided into two members in the horizontal direction along the lengthwise direction of the annular core that includes the cores 12, 13A, and 13B, the joining forces between the annular core that includes the cores 12, 13A, 13B and the bobbin 14 can be enhanced. Accordingly, a misalignment of the cores 12, 13A and 13B relative to one another can be prevented, and a detachment of the joined cores can be also prevented.

When bolts are inserted in the collars 36 integrally molded with the bobbin 14, and the reactor 20 is fastened to a casing, etc., a linear expansion difference between the casing and the reactor 20 occurs, and thus the adhesive 51 applied to the joining surfaces of the cores 12, 13A, and 13B may be damaged. Hence, according to conventional technologies, a fixation structure is necessary to absorb the linear expansion difference, but according to the reactor 20 of this embodiment, since a misalignment of the cores 12, 13A and 13B relative to one another and a detachment of the joined cores can be surely prevented, such a fixation structure to absorb the linear expansion difference is unnecessary.

(2) When the adhesive 51 that overflows from the joining surfaces of the cores 12, 13A, and 13B may reach the dividing surfaces 50 of the bobbin 14, this adhesive may be cured at such locations. In this case, a structure in which the positions of the dividing surfaces 50 of the bobbin 14 are displaced from the positions of the joining surfaces of the cores 12, 13A, and 13B is effective.

That is, the adhesive 51 that overflows from the joining surfaces of the cores 12, 13A, and 13B does not push up the internal wall surface of the bobbin 14 from the sides where the cores 12, 13A, and 13B are placed, and thus the overflowing adhesive 51 does not affect the joining of the divided first and second bobbin members 24, 34. In addition, when the adhesive 51 overflows from the joining surfaces of the cores 12, 13A, and 13B, the bobbin 14 is always present around the bonded portions. Accordingly, the overflowing adhesive 51 always sticks to the internal wall surface of the bobbin 14, enhancing the bonding force.

(3) The bobbin 14 is formed with the openings 52, 53 where the adhesive 51 overflows to the exterior of the bobbin 14 from the bobbin-internal-wall-surface side. Hence, the overflowing adhesive 51 through the openings 52, 53 sticks to the coils 11 located outside the bobbin 14, and thus the bobbin 14 and the coils 11 can be firmly bonded together. In this case, even if the adhesiveness between the resin itself of the bobbin 14 and the coils 11 is not excellent, by applying the adhesive 51 that has an excellent adhesiveness to the coils 11, the bobbin 14 and the coils 11 can be further surely joined with each other.

(4) Since the positions of the openings 52, 53 overlap the respective joining surfaces of the cores 12, 13A and 13B, the overflowing adhesive 51 from the joining surfaces of the cores 12, 13A, and 13B can easily reach the openings 52, 53. Accordingly, the adhesive 51 can smoothly overflow to the exterior of the bobbin 14 through the openings 52, 53. This enables a further firm bonding of the bobbin 14 with the coils 11.

(5) The three openings 52, 53 arranged side by side are all disposed near the center of the I-shaped core 12 in the width direction. Hence, the adhesive 51 that overflows from such locations may bond the coils 11 at the substantial center of the bobbin 14. Accordingly, the bonding of the coils 11 to the bobbin 14 can be well balanced.

(6) Since the openings 52, 53 are formed as slits along the respective joining surfaces of the cores 12, 13A, and 13B, a large amount of adhesive 51 can overflow. In addition, it is easy to control the shape of the overflowing adhesive 51 to the exterior. Therefore, the bobbin 14 and the coils 11 can be surely bonded together at a desired location.

### Other Embodiments

The above embodiments are merely presented as examples in this specification, and the present invention should not be limited to the above embodiments, and can be modified as needed within the scope of a technical though as recited in the appended claims.

(1) Embodiment of Casing for Reactor

A structure in which the reactor is fastened to a casing can be selected as needed, and fastening force may be enhanced by, for example, screwing using bolts. In addition, a reactor may be placed in a single casing, or the plural reactors may be placed in a single casing.

(2) Other Embodiment of Cores

The annular core is not limited to the above embodiments, and J-shaped cores and I-shaped cores may be applied instead of the U-shaped core. In this case, cores of a single type may be applied, or a combination of cores of different types may be adopted. In addition, an annular core in a θ shape that includes E-shaped cores may be adopted, or a circular or an angular loop core may be employed.

In the above embodiments, only one U-shaped core is inserted in the divided two bobbin members, but the number of cores to be inserted may be equal to or greater than two. The number of I-shaped core and that of gap spacers attached inside the dividable bobbin are not limited to those illustrated in the figures, and may be equal to or greater than or be equal to or smaller than the illustrated number.

As for the attaching work of the I-shaped core and the gap spacer to the divided bobbin member, and the attaching work of the coils to the bobbin, the sequence of those works is not limited to any particular order, and either work can be done first.

The joining surfaces of the core pieces may be designed so as to have an elongated outer circumference of the joining surface like a zig-zag shape that can enable a large amount of adhesive to overflow from the joining surfaces of the core pieces. In this case, the zig-zag shape of the joining surface may be linear, or may be curved. Still further, slits may be provided at the outermost circumference of the joining surfaces of the core pieces so as to facilitate the adhesive to overflow from the joining surfaces of the core pieces. such slits may be also formed in the gap spacers.

(3) Other Embodiment of Bobbin

The bobbin can cover the following other embodiment. The number of divided bobbin members and the shape of the divided bobbin member can be modified as needed. For example, in the second embodiment, the positions of the dividing surfaces of the bobbin are displaced from the positions of the joining surfaces of the cores, it is not always necessary that those positions are displaced, and the positions of the dividing surfaces of the bobbin may be consistent with the positions of the joining surfaces of the core pieces. In this case, the applied adhesive can still overflow from the joining surfaces of the core pieces, and stick to the internal wall surface of the bobbin.

That is, in the above second embodiment, the positions of the dividing surfaces of the bobbin and those of the joining surfaces of the core pieces are displaced, and the adhesive is applied to the joining surfaces of the core pieces so as to overflow from the joining surfaces and stick to the internal wall surface of the bobbin. The present invention is not limited to this structure, and covers an embodiment in which an adhesive is applied to the joining surfaces of the core pieces so as to overflow from the joining surfaces and stick to the internal wall surface of the bobbin. Such an embodiment is applicable to conventional technologies that have the positions of the dividing surfaces of the bobbin members consistent with the positions of the joining surfaces of the core pieces. Therefore, conventional structural elements are efficiently utilized without changing the structure of the bobbin and that of the core.

In the above embodiments, the cylindrical portions that support the respective I-shaped cores are provided at one of the divided bobbin members, but the number of bobbin members provided with the cylindrical portions may be equal to or greater than three. In addition, the shape of the cylindrical portion that supports the I-shaped core and the length can be changed as needed. Still further, in order to facilitate the attachment of the I-shaped core, a part of the cylindrical portion may be dividable or movable.

(4) Other Embodiment for Openings

The openings through which the adhesive overflows from the bobbin-internal-wall-surface side may employ the following other embodiment. For example, respective cut-outs provided at the dividing surfaces of the bobbin members may form the opening when contacting with each other. According to this embodiment, the opening can be formed simultaneously with the assembling of the bobbin. Therefore, a work of forming the opening can be eliminated, thereby reducing the costs.

The positions, number, and shape of the opening in the bobbin can be selected freely, and for example, the number of slits and the pitch can be selected as needed. In addition, the shape of the opening is not limited to a slit, but may be a circle or a cross.

What is claimed is:

1. A reactor comprising:
a core comprising a plurality of core pieces joined one another;
a coil wound around at least a part of the core; and
a bobbin that is dividable and provided between the core and the coil,
a dividing surface of the bobbin being displaced from a position of a joining surface of the core pieces with the bobbin being provided between the core and the coil.

2. A reactor comprising:
a core comprising a plurality of core pieces joined one another;
a coil wound around at least a part of the core; and
a bobbin provided between the core and the coil,
an adhesive being applied to a joining surface of the core pieces so as to overflow from the joining surface and stick to an internal wall surface of the bobbin.

3. A reactor comprising:
a core comprising a plurality of core pieces joined one another;
a coil wound around at least a part of the core; and
a bobbin that is dividable and provided between the core and the coil,
a dividing surface of the bobbin being displaced from a position of a joining surface of the core pieces with the bobbin being provided between the core and the coil; and
an adhesive being applied to the joining surface of the core pieces so as to overflow from the joining surface and stick to an internal wall surface of the bobbin.

4. The reactor according to claim 1, wherein:
the core comprises an I-shaped core around which the coil is wound; and
the dividing surface of the bobbin is located near a center of the I-shaped core such that divided two members of the bobbin cover the I-shaped core evenly.

5. The reactor according to claim 3, wherein:
the core comprises an I-shaped core around which the coil is wound; and
the dividing surface of the bobbin is located near a center of the I-shaped core such that divided two members of the bobbin cover the I-shaped core evenly.

6. The reactor according to claim 2, further comprising an opening formed on the bobbin,
wherein the adhesive overflows to an exterior of the bobbin from bobbin-internal-wall-surface side through the opening.

7. The reactor according to claim 6, wherein the opening is disposed near the joining surface of the core pieces.

8. The reactor according to claim 7, wherein the opening is disposed near a center in a width direction of the core piece.

9. The reactor according to claim 6, wherein the opening is formed along the joining surface of the core pieces.

10. The reactor according to claim 1, wherein:
the core comprises a pair of leg portions, and a yoke portion with a resin member molded therearound;
the bobbin formed integrally with the resin member is provided at the pair of leg portions; and
a positioning portion guiding a drawn wire from the coil is integrally formed with the yoke portion.

11. The reactor according to claim 2, wherein:
the core comprises a pair of leg portions, and a yoke portion with a resin member molded therearound;
the bobbin formed integrally with the resin member is provided at the pair of leg portions; and
a positioning portion guiding a drawn wire from the coil is integrally formed with the yoke portion.

12. The reactor according to claim 3, wherein:
the core comprises a pair of leg portions, and a yoke portion with a resin member molded therearound;
the bobbin formed integrally with the resin member is provided at the pair of leg portions; and
a positioning portion guiding a drawn wire from the coil is integrally formed with the yoke portion.

13. The reactor according to claim 1, further comprising a cylindrical portion provided at at least one of divided members of the bobbin, and supporting the core piece.

14. The reactor according to claim 2, further comprising a cylindrical portion provided at at least one of divided members of the bobbin, and supporting the core piece.

15. The reactor according to claim 3, further comprising a cylindrical portion provided at at least one of divided members of the bobbin, and supporting the core piece.

16. The reactor according to claim 1, wherein:
the core comprises an annular core;
the annular core comprises U-shaped cores disposed so as to face with each other, and I-shaped cores held between the U-shaped cores and joined with the U-shaped cores; and
the bobbin is dividable in a direction orthogonal to an axial direction of the annular core.

17. The reactor according to claim 2, wherein:
the core comprises an annular core;
the annular core comprises U-shaped cores disposed so as to face with each other, and I-shaped cores held between the U-shaped cores and joined with the U-shaped cores; and
the bobbin is dividable in a direction orthogonal to an axial direction of the annular core.

18. The reactor according to claim 3, wherein:
the core comprises an annular core;
the annular core comprises U-shaped cores disposed so as to face with each other, and I-shaped cores held between the U-shaped cores and joined with the U-shaped cores; and
the bobbin is dividable in a direction orthogonal to an axial direction of the annular core.

19. The reactor according to claim 1, wherein the core piece comprises a powder magnetic core.

20. The reactor according to claim 2, wherein the core piece comprises a powder magnetic core.
